(19) United States
(12) Patent Application Publication
(10) Pub. No.: US 2026/0322102 A1
(43) Pub. Date: Oct. 15, 2026

(54) MODULATED LIGHT-BASED COMMUNICATION FOR DATA TRANSFER AND SYSTEM PROTECTION FOR ELECTRICAL POWER DISTRIBUTION SYSTEMS

(71) Applicant: Utility Relay Company, Ltd., Chagrin Falls, OH (US)

(72) Inventors: Helmut Weiher, Auburn Township, OH (US); Ryan J. McClarnon, Brunswick, OH (US)

(73) Assignee: Utility Relay Company, Ltd., Chagrin Falls, OH (US)

(21) Appl. No.: 18/834,396

(22) PCT Filed: Dec. 20, 2023
(86) PCT No.: PCT/US2023/085052

§ 371 Date: Jul. 30, 2024

(51) Int. Cl. H02H 1/00; H02H 7/26; H02H 7/30

(52) U.S. Cl. CPC H02H 1/0069; H02H 7/261; H02H 7/30

(57) ABSTRACT

Provided is an optical wireless communication system for circuit breaker protection relays that includes modulated unguided light to carry a signal for bidirectional communication between circuit breaker protection relays and a controller. An optical wireless communication system for circuit breaker protection relays that includes modulated unguided light for communication in one direction and RF communication in the other direction is also provided.

### BACKGROUND OF THE DISCLOSURE

### Field of the Disclosure

The following description relates generally to low voltage and medium voltage circuit protection systems, and in particular to an Optical Wireless Communication (“OWC”) network or a hybrid OWC and Radio Frequency (“RF”) communication network used for the purposes of data transfer, breaker control, and electrical system-based protection for low voltage and medium voltage power distribution systems.

### Description of Related Art

Circuit breakers are used in electrical distribution systems to isolate an overloaded or faulted circuit from its power source, as well as to provide a means for disconnecting a circuit from its power source. Low voltage AC circuit breakers are used in power systems where the line-to-line system voltages are 600 Volt RMS or less. Low voltage DC circuit breakers are used in power systems where the system voltage is 1,000 Volt or less. Medium voltage AC circuit breakers are used in power systems where the line-to-line system voltages are between 1 and 35 kV (1,000 and 35,000 Volt). Medium voltage DC circuit breakers are used in power systems where the system voltage is 1,000 Volt or higher.

Circuit breakers are typically housed in separate designated cubicles which are part of a switchgear assembly, also known as a switchgear line-up. Traditionally, low voltage circuit breakers have direct-acting (powered by the circuit breaker load current), integral protection devices that monitor the current through the breaker and act to trip (open) the circuit breaker during an overload or fault event, thereby interrupting the overload or fault. The electronic version of direct-acting protection devices are commonly called trip units. Traditionally, medium voltage and high voltage circuit breakers do not have integral protection devices, but use separately mounted protection devices that are powered by a reliable control power source, and which monitor the current through the breaker and signal the breaker to trip (open), thereby interrupting the overload or fault. These separately mounted and separately powered protection devices are commonly called protection relays. The term “relay” herein will refer to a trip unit used in low voltage switchgear or a protection relay used in medium and high voltage switchgear.

Although the relays provide adequate basic overload and fault protection for the load connected to their circuit breakers, the overall protection of the power distribution system could be improved if there was a communication means that interconnected the circuit breaker relays in a switchgear line-up.

In addition to providing for system-based protection, a communication means between relays is useful for other purposes, such as data transfer, circuit breaker control, and circuit breaker racking control, as examples. If the communication means is digitally based, then it can be more flexible, and future upgrades can be made easier since they can be accomplished with firmware upgrades rather than hardware upgrades. Additionally, a wireless rather than wired digital communication means would greatly simplify a retrofit installation into existing switchgear line-ups. A wired communication system is easily installed during manufacture of a switchgear line-up; however, it is difficult to install after the switchgear line-up is in service since a shutdown is usually required to install the wiring.

Information transfer between the circuit breaker relays and a computer controller is historically implemented via wired connections. Recently, radio frequency (RF) based wireless connections have been implemented.

Both wired and RF based wireless communication for relays on circuit breakers have limitations. Communication in wired systems can be disrupted by induced voltages from nearby current carrying conductors, especially during a fault event. Additionally, adding a wired communication system to existing switchgear as a retrofit is difficult since a shutdown is usually required to add the wired communication system. RF based wireless communication can be affected by electromagnetic interference or other RF devices. A duplex RF communication system (e.g., RF communication for both outbound and inbound signals) provides less security because the RF wireless communication range usually extends outside of the switchgear room and is subject to malicious interference. Typically, the latency of messages in a duplex RF based communication system also limits its use to information transfer, circuit breaker control, and circuit breaker racking control, but precludes its use for system-based overload and fault protection.

RF communication is highly regulated and there are a multitude of different wireless RF standards and technologies that have been developed and that could be used in the implementation of a wireless communication system for a system-based overload and fault protection of switchgear. The RF communication standards and technologies fall into a few groups; short range (e.g., ZigBee, Bluetooth, Bluetooth Low Energy and Thread, as examples), intermediate range (e.g., Wi-Fi as an example) and long range (e.g., 3G and 4G Cellular, as examples).

In order to be effectively used for system protection on switchgear, the used communication medium must meet the following requirements:
a) Fast data transfer.
b) Robust communication, especially during an EMI generating arcing fault event.
c) Secure communication resistant to outside interference that could unintentionally or intentionally interfere with the proper operation of the system-based protection schemes.

In addition to system-based electrical protection, a wireless communication system could also be used for data gathering. Additionally, the wireless communication system could also provide circuit breaker control which may include but is not limited to circuit breaker close command, circuit breaker trip command, and various circuit breaker racking commands.

It would, therefore, be desirable to provide a wireless switchgear communication system that would offer higher bandwidth, higher transmission speed, lower latency, and with increased security due to an easily controllable limited active area. Both a duplex OWC system and a hybrid OWC system meet these requirements.

### SUMMARY

The following presents a simplified summary of the invention in order to provide a basic understanding of some example aspects of the invention. This summary is not an extensive overview of the invention. Moreover, this summary is not intended to identify critical elements of the invention or to delineate the scope of the invention. The sole purpose of the summary is to present some concepts in a simplified form as a prelude to the more detailed description that is presented later.

Example embodiments of the present disclosure relate to a wireless communication system for electrical switchgear. One implementation of this wireless communication system is a full duplex OWC system in which both communication to and communication from a circuit breaker relay are modulated light based using unguided visible light, IR, or UV radiation.

Another implementation of the wireless communication system is a hybrid OWC system where communication to the circuit breaker relays is modulated light based and communication from the circuit breaker relays is RF based.

These implementations of wireless switchgear communication can provide system based electrical protection, such as zone selective interlocking (ZSI) protection, differential protection, breaker failure, and main-tie-main ground fault protection (MTM GF) protection, for example, as well as provide for data transfer from and to the circuit breaker relays, circuit breaker control, and circuit breaker racking control.

The switchgear wireless communication system can be implemented in multiple ways including but not limited to via the use of duplex OWC access points, hybrid OWC access points, duplex OWC relays, hybrid OWC relays, and OWC transmitters.

The duplex OWC access point has a wired connection to a computer controller which controls the communication system, provides the system-based electrical protection, is the repository of the system data, and initiates circuit breaker commands including racking commands. The computer controller originates messages for the relays and sends them (via Ethernet format for example) to the OWC access point which transmits the message to the intended relay via a modulated light signal. The duplex OWC access point receives the reply message from the intended relay via a modulated light signal, converts the reply message to an Ethernet format for example and forwards the reply message to the computer controller.

The duplex OWC relay is not connected to a computer controller. It receives a message via a modulated light signal and relays this message by re-transmitting the message via a modulated light signal to the intended recipient. Messages can be sent to the OWC relay for re-transmission from a relay or from a computer controller. The communication system is controlled by one of the relays in the OWC network, such as the main circuit breaker relay for example, or by a computer controller that is part of the OWC network.

The hybrid OWC access point has a wired connection to a computer controller which controls the communication system, provides the system-based electrical protection, is the repository of the system data, and initiates circuit breaker commands including racking commands. The computer controller originates messages for the relays and sends them (via Ethernet format for example) to the hybrid OWC access point which transmits the message to the intended relay via a modulated light signal. The RF based reply message from the relay can be received either by the hybrid access point or directly by the computer controller. If received by the hybrid access point, the RF messages are converted to an Ethernet format for example and forwarded to the computer controller.

The modulated light transmitter in the duplex and hybrid OWC access points and OWC relays are implemented utilizing a high-power modulated light signal which are LED based, for example. The duplex and hybrid OWC access points and OWC relays are preferably located overhead, but could be located otherwise, in order to flood the switchgear area containing the circuit breaker relays with relatively high intensity modulated light. By flooding the area with high intensity modulated light, the OWC receivers, operatively coupled to the circuit breaker relays, can be smaller and less sensitive. Additionally, flooding the receiver area with high intensity modulated light increases the likelihood of reflected light reaching an OWC receiver that otherwise has the direct line-of-sight temporarily blocked.

The modulated light receiver in the duplex OWC access points and OWC relays are implemented using a very sensitive photodetector such as a photon avalanche diode for example, capable of detecting the low level modulated light signals from the circuit breaker relays.

### BRIEF DESCRIPTION OF THE DRAWINGS

The foregoing and other aspects of the present disclosure will become apparent to those skilled in the art to which the present disclosure relates upon reading the following description with reference to the accompanying drawings, in which:

FIG. 1 is a simplified 1-line diagram of a typical traditional bus differential protection scheme using a differential protection relay and wired dedicated current transformers (CTs);

FIG. 2 is a simplified 1-line diagram of a typical traditional zone selective interlocking (ZSI) protection scheme where all feeder circuit breaker relays are connected to a ZSI signal wiring bus which is in turn connected to the main circuit breaker relay;

FIG. 3 is a simplified 3-line diagram of a typical traditional MTM GF protection on a 4-wire double ended switchgear;

FIG. 4 is a simplified 1-line diagram of a single ended switchgear with a duplex OWC network including the circuit breaker relays and a computer controller communicating via an OWC access point, and the communication network is controlled by the computer controller, according to an embodiment;

FIG. 5 is a simplified 1-line diagram of a single ended switchgear with a duplex OWC network including the circuit breaker relays and a computer controller communicating via multiple duplex OWC access points, and the communication network is controlled by the computer controller, according to an embodiment;

FIG. 6 is a simplified 1-line diagram of a single ended switchgear with a duplex OWC network including the circuit breaker relays where the communication messages are relayed by multiple duplex OWC relays, and the communication network is controlled by the main circuit breaker relay, according to an embodiment;

FIG. 7 is a simplified 1-line diagram of a single ended switchgear with a duplex OWC network including the circuit breaker relays and multiple duplex OWC relays showing the possible optical signal paths, and the communication network is controlled by the main circuit breaker relay, according to an embodiment;

FIG. 8 is a simplified 1-line diagram of a single ended switchgear with a duplex OWC network including the circuit breaker relays and a computer controller where the communication messages are relayed by multiple duplex OWC relays, and the communication network is controlled by the computer controller, according to an embodiment;

FIG. 9 is a simplified 1-line diagram of a single ended switchgear with a hybrid OWC network including the circuit breaker relays, a computer controller and a hybrid OWC access point where the communication messages are sent by the hybrid OWC access point using modulated light but are received by the hybrid OWC access point using RF signals, and the communication network is controlled by the computer controller, according to an embodiment; and

FIG. 10 is a simplified 1-line diagram of a single ended switchgear with a hybrid OWC network including the circuit breaker relays, a computer controller, and an OWC transmitter where the communication messages are sent by the hybrid OWC transmitter using modulated light but are received by the computer controller using RF signals, and the communication network is controlled by the computer controller, according to an embodiment.

### DETAILED DESCRIPTION

The present disclosure will now be described with reference to the drawings, wherein like reference numerals are used to refer to like elements throughout. It is to be appreciated that the various drawings are not necessarily drawn to scale from one figure to another nor inside a given figure, and in particular that the size of the components are arbitrarily drawn for facilitating the understanding of the drawings. In the following description, for purposes of explanation, numerous specific details are set forth in order to provide a thorough understanding of the present disclosure. It may be evident, however, that the present disclosure can be practiced without these specific details. Additionally, other embodiments of the present disclosure are possible, and the present disclosure is capable of being practiced and carried out in ways other than as described. The terminology and phraseology used in describing the present disclosure is employed for the purpose of promoting an understanding of the disclosed embodiments and should not be taken as limiting.

Low voltage and medium voltage switchgear can incorporate several types of electrical protection schemes that require a system-based approach. These system-based protection schemes need information from multiple circuit breaker relays. System-based electrical protection schemes include but are not limited to current differential protection, zone selective interlocking (ZSI), main-tie-main ground fault protection (MTM GF) for 4-wire double ended switchgear, and breaker failure.

There are several issues with the implementation of differential protection as a retrofit on existing switchgear:
a) A shutdown of the switchgear is required to install the differential protection equipment and wiring.
b) Multiple sets of dedicated CTs and the associated CT wiring along with a dedicated differential protection relay are required.
c) A disconnecting means between the main circuit breaker and its cubicle must be provided for the trip signal wiring from the differential relay if the main circuit breaker is of draw-out construction.
d) Installation of the dedicated CTs would require splitting the switchgear bus in multiple locations.

The implementation of differential protection in a retrofit situation can be greatly simplified if the information from the already existing current sensors associated with the circuit breaker relays could be used for differential protection. Additionally, if a wireless means is available to gather the required information from the relays, then the need for dedicated wiring is eliminated.

There are several short comings in the traditional wired implementation of ZSI protection:
a) The restraint signals from the feeder breaker relays are all wired in parallel so there is no means of determining which relay originated the restraint signal.
b) There is no means of determining what protection function triggered the restraint signal and at what current level.
c) There is the potential of a feeder circuit breaker relay issuing a restraint signal for a fault outside of the zone which masks a concurrent fault within the zone.
d) In the traditional wired implementation of ZSI protection there is no supervisory monitoring of the integrity of the ZSI wiring.

There are several issues with the implementation of ZSI protection as a retrofit on existing switchgear:
a) A shutdown of the switchgear is required to install the ZSI wiring.
b) If the circuit breakers are draw-out (removable), additional ZSI wiring disconnecting means must be provided on the circuit breakers and their cubicles so that the breakers can be withdrawn.

The implementation of ZSI in a retrofit situation can be greatly simplified if a wireless means is available to gather the restraint information from the feeder circuit breaker relays, then the need for dedicated wiring is eliminated. Additionally, the operation of the ZSI protection system in general would be greatly improved if the communication system included a supervisory system and if additional pertinent information was included with the restraint signal.

The MTM GF protection schemes are normally implemented at the time of construction for newer switchgear, but it would not have been implemented in older switchgear that did not originally provide GF protection.

There are several issues with the implementation of MTM GF protection as a retrofit on existing double ended 4-wire switchgear:
a) A shutdown of the switchgear is required to install the neutral CTs and wiring.
b) Installation of the neutral CTs would require splitting the switchgear bus in multiple locations.
c) On low voltage switchgear if the circuit breakers are draw-out (removable), additional neutral CT wiring disconnecting means must be provided on the circuit breakers and their cubicles so that the breakers can be withdrawn.

There are many mediums that can be used to implement a wireless communication system for system-based protection on switchgear. They fall into three basic categories:
a) Communication over the radio frequency (RF) spectrum.
b) Communication over the visible, IR or UV light spectrums.
c) Hybrid communication over both the RF spectrum and the light spectrum.

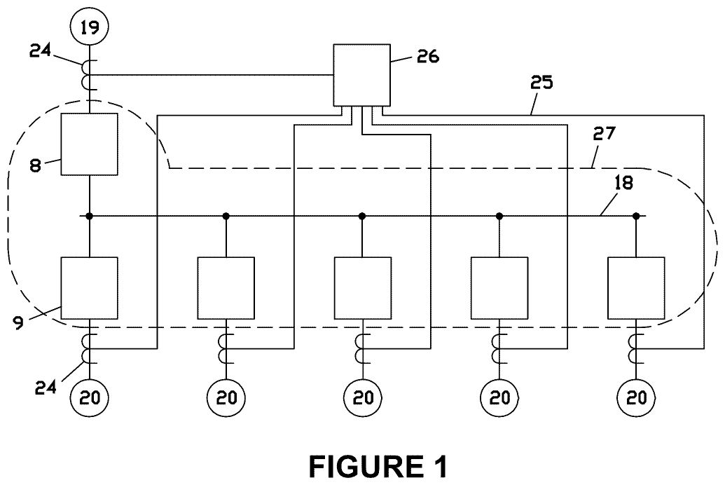

As shown in FIG. 1, the traditional current differential protection is a system-based protection method to provide phase and ground fault protection within a zone of protection with the shortest possible time delay while maintaining selective coordination for phase and ground faults outside of the zone of protection. To form the zone of protection, current transformers (CTs) 24 are located in strategic positions to measure current entering and leaving the zone 27. Based on Kirchhoff's conservation of current law, if more current enters the zone, than leaves the zone, a fault exists in the zone of protection.

In the traditional current differential protection as shown in FIG. 1, all normal current paths into or out of the switchgear bus 18 are measured with CTs 24. These CTs 24 are located to measure the current entering the zone 27 from the energy source 19 and currents leaving the zone to the energy consuming loads 20. The CTs 24 are wired 25 to a dedicated current differential protection relay 26. The relay 26 will signal the main circuit breaker 8 to trip (open) and disconnect the power source 19 from the switchgear bus 18 with minimum delay if the phase or GF currents entering the zone 27 is substantially greater than the phase or GF currents leaving the zone 27 thereby interrupting a fault within the zone.

As shown in FIG. 1, a basic implementation of phase and ground fault differential protection requires the wiring of multiple CTs 24 to a central protection relay 26. Although the information provided by the differential scheme CTs 24 is redundant to that of the current sensors (not shown) associated with the circuit breaker relays, the differential protection relay 26 requires these dedicated CTs.

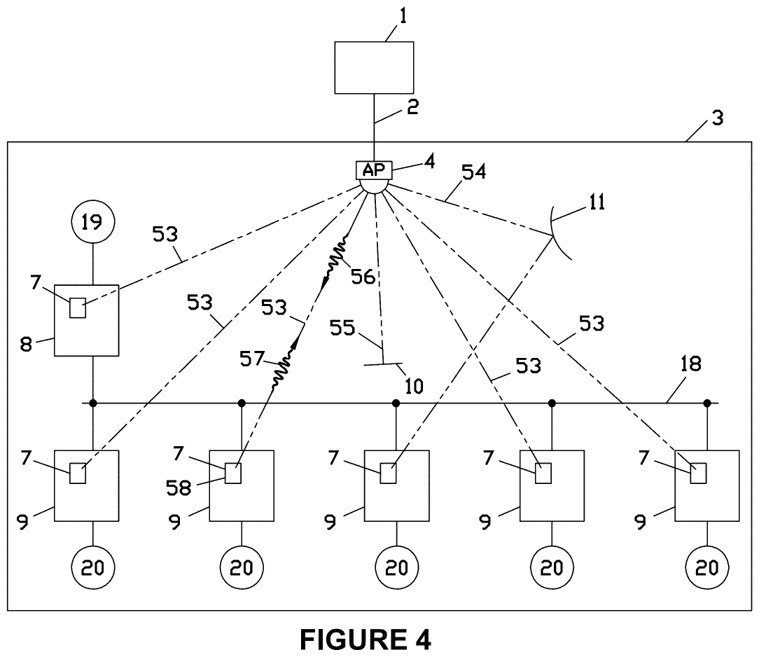

Therefore, a communication based current differential protection scheme, as illustrated in FIG. 4 through FIG. 10, which utilizes the information already known by the relays and which eliminates the need for dedicated CTs 24 and a dedicated central protection relay 26, is more economical to implement and provides additional features, such as supervisory monitoring of the current differential protection scheme, for example.

Zone selective interlocking (ZSI) is another system-based protection method to provide phase and ground fault protection within a zone of protection with the shortest possible time delay while maintaining selective coordination for phase and ground faults outside of the zone of protection. Historically ZSI protection was accomplished with a rudimentary wired implementation of communication between relays in a switchgear line-up.

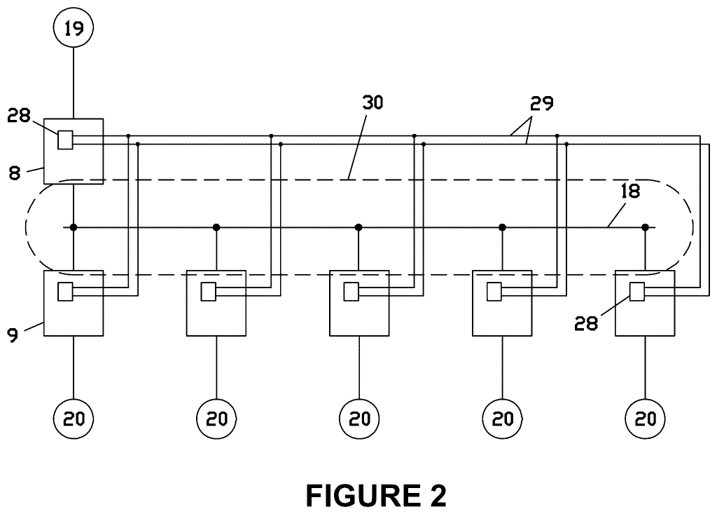

As shown in FIG. 2, a basic implementation of traditional ZSI protection requires inter-relay communication wiring between the relay associated with a main circuit breaker 8 and the relays associated with the feeder circuit breakers 9. This information transfer communication is traditionally accomplished by wiring 29 between the feeder circuit breaker relays and the main circuit breaker relay. These wiring interconnected relays form a zone of protection 30.

In its usual implementation, the wiring 29 for ZSI is only capable of transmitting one logic state of “restraint” to the main circuit breaker 8 relay 28 from one of the downstream circuit breaker 9 relays 28. Additionally, the communication wiring may be complicated on double ended substations which include two main circuit breakers and a tie circuit breaker.

Therefore, a communication based ZSI protection scheme, as illustrated in FIG. 4 through FIG. 10, which eliminates the need for dedicated wiring 29, is more economical to implement and provides additional features, such as supervisory monitoring of the ZSI protection scheme, for example.

Main-Tie-Main ground fault (MTM GF) protection on a 4-wire doubled ended switchgear is another system-based protection scheme.

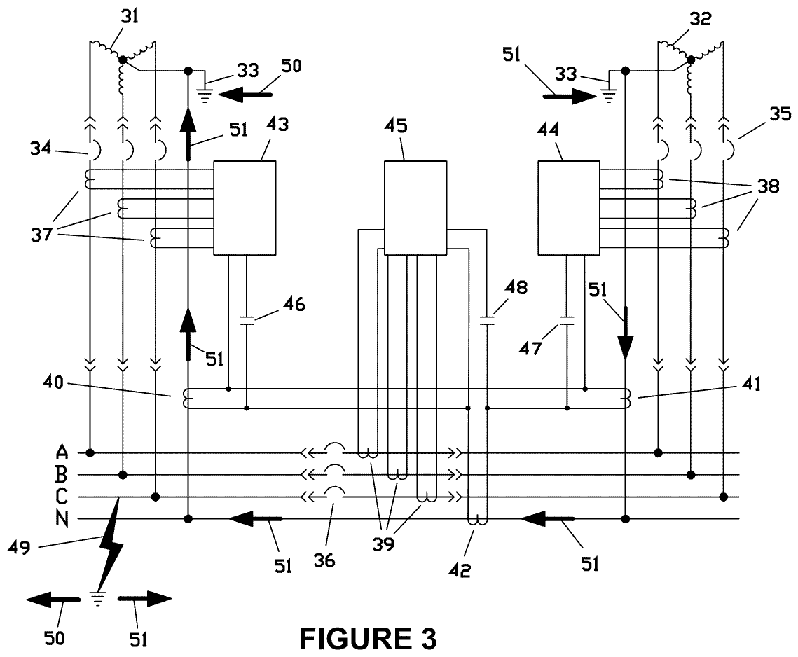

Implementing the MTM GF protection is not straightforward. FIG. 3 is a 3-line illustration of a traditional MTM GF protection scheme where only two of the main circuit breakers and tie circuit breaker are allowed to be closed at any particular time. The first main circuit breaker 34 has an associated relay 43 with phase CTs 37 and a neutral CT 40. The second main circuit breaker 35 has an associated relay 44 with phase CTs 38 and a neutral CT 41. The tie circuit breaker 36 has an associated relay 45 with phase CTs 39 and a neutral CT 42.

If the neutral points of both source transformers 31 and 32 are grounded 33, as shown in FIG. 3, then the difficulty is due to the two paths available for a GF current returning to the source transformer resulting in GF current 50 and GF current 51. If not mitigated, the portion of the GF current 51 returning through the non-source transformer neutral ground will be falsely measured as legitimate neutral current and not as GF current. To mitigate the impact of the two GF current return paths, the neutral CT 40 associated with the first main circuit breaker 34, the neutral CT 41 associated with the second main circuit breaker 35, and the neutral CT 42 associated with the tie circuit breaker 36 must be wired in a particular fashion so that the relays can properly measure the GF current. Additionally, this wiring must include breaker open/closed status in the form of an “a” contact 46 from the first main circuit breaker, an “a” contact 47 from the second main circuit breaker, and an “a” contact 48 from the tie circuit breaker.

As shown in FIG. 3, a phase to ground fault current 49 splits into two currents 50 and 51. The GF current 50 returns to the source transformer 31 neutral point without passing through any neutral CTs and is therefore correctly measured as GF current by relay 43. The other portion of the GF current 51 returns to the source transformer 31 neutral point via the path through the non-source transformer 32 neutral ground and passes through the neutral CTs 41, 42 and 40 thereby corrupting the GF calculations.

Although a shutdown would still be required to install the neutral CTs, the implementation of MTM GF can be greatly simplified if a wireless means, as illustrated in FIG. 4 through FIG. 10, for example, is available to gather the neutral CT current information and the breaker open/close status from the main circuit breakers and tie circuit breaker, then the need for dedicated wiring is eliminated. Additionally, the operation of the MTM GF protection system in general would be greatly improved if the communication system included a supervisory system.

Breaker failure protection is not normally applied in low voltage and is not always applied in medium voltage switchgear, but could be of benefit. Normally overload and fault protection is selectively time coordinated. That is, if an overload or fault occurs, all circuit breakers in the current path detect the event but the closest circuit breaker operates first to isolate the event. The next upstream circuit breaker provides time delayed backup protection in case the closest circuit breaker fails to interrupt the fault. However, if there is a problem at the closest circuit breaker so that it is not able to interrupt the fault, then there is a needles time delay before the next upstream circuit breaker interrupts the fault.

If a feeder circuit breaker relay detects an overload or fault condition but is unable to trip its circuit breaker because of a problem such as an open circuit to its actuator or trip coil as an example, it can communicate this breaker failure to the next upstream circuit breaker relay which could then operate without additional time delay to interrupt the overload or fault. A wireless means of communication, as illustrated in FIG. 4 through FIG. 10, for example, would facilitate the implementation of a breaker failure protection scheme.

FIG. 4 illustrates a possible implementation of a duplex OWC system for a single ended switchgear wherein the energy source 19 is connected to a main circuit breaker 8. The main circuit breaker 8 in turn is connected to the switchgear bus 18 which has multiple feeder circuit breakers 9 connected to it and which supply various loads 20. Both the main circuit breaker 8 and the feeder circuit breakers 9 contain relays 7 which are each operatively connected to or contain an OWC transceiver. Although FIG. 4 illustrates a simple single ended switchgear, this OWC system can be applied to other types of switchgear configurations.

This OWC system illustrated in FIG. 4 uses a duplex OWC access point 4 with a wired connection 2 to a computer controller 1. The wired connection 2 could be an Ethernet connection, as an example. The computer controller 1 can include one or more of a microprocessor, a microcontroller that includes a central processing unit (CPU), a memory, an input/output interface, a digital signal processor (DSP), an application specific integrated circuit (ASIC), a field-programmable gate array (FPGA), discrete logic circuitry, or the like. The duplex OWC access point 4 receives a message in digital electronic format from the computer controller 1 over the wired connection 2 and transmits this message containing the address of the intended relay recipient 58 via a modulated light signal 56. The recipient relay 58 in turn responds with a reply message containing the requested data via a modulated light signal 57 addressed to the duplex OWC access point 4. The duplex OWC access point 4 converts the optical reply message into digital electronic format and forwards the reply message via the wired connection 2 to the computer controller 1.

As illustrated in FIG. 4, the duplex OWC signals are line-of-sight between the OWC access point 4 and the multiple relays 7 along communication line-of-sight paths 53. In case of a signal blocking object 10, the direct line-of-sight signal is blocked and a reflected communication path 54 is used from an optical reflector 11.

In the FIG. 4 example, the communication system is under the control of the computer controller 1 which coordinates the collection of data from the multiple circuit breaker relays 7. The computer controller 1 uses the collected data from the relays 7 to provide system-based electrical protection for the switchgear and logging of the collected data. Additionally, the computer controller 1 can send data and commands to the relays 7. The optically opaque barrier 3 limits the active communication area.

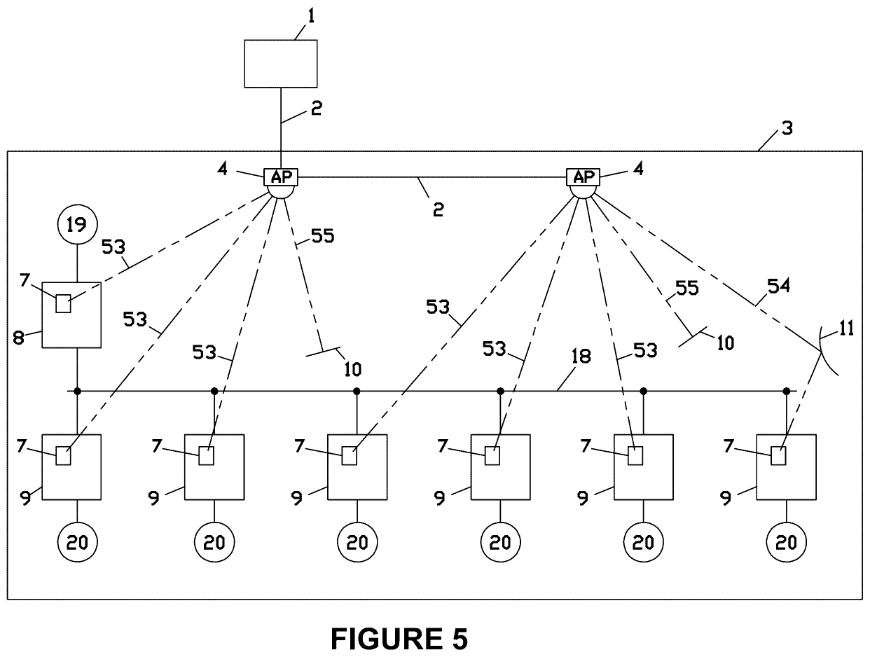

FIG. 5 illustrates a similar duplex OWC system for a single ended switchgear as the one illustrated in FIG. 4, but includes multiple duplex OWC access points 4, only two of which are shown in this figure. The multiple duplex OWC access points 4 are interconnected with a wired connection 2. The wired connection 2 could be an Ethernet connection, as an example. One possible configuration of line-of-sight optical communication paths 53 is shown. The optically opaque barrier 3 limits the active communication area.

As illustrated in FIG. 5, the multiple duplex OWC access points 4 allocate the communication to the multiple relays 7 based on communication parameters such as the signal strength received from the relays 7, as an example. If a particular duplex OWC access point 4 loses communication to one of its allocated relays 7 due to a blocking object 10 over optical path 55, as an example, communication to that blocked relay is transferred to a different duplex OWC access point. Alternatively, if line-of-sight communication 55 is blocked by an object 10, the communication to that relay may still be possible utilizing a reflected OWC signal path 54 from an optical reflector 11. Transferring the communication task to a different duplex OWC access point or relying on a reflected OWC signal is determined based on communication parameters, such as the signal strength received from the blocked relay, as an example.

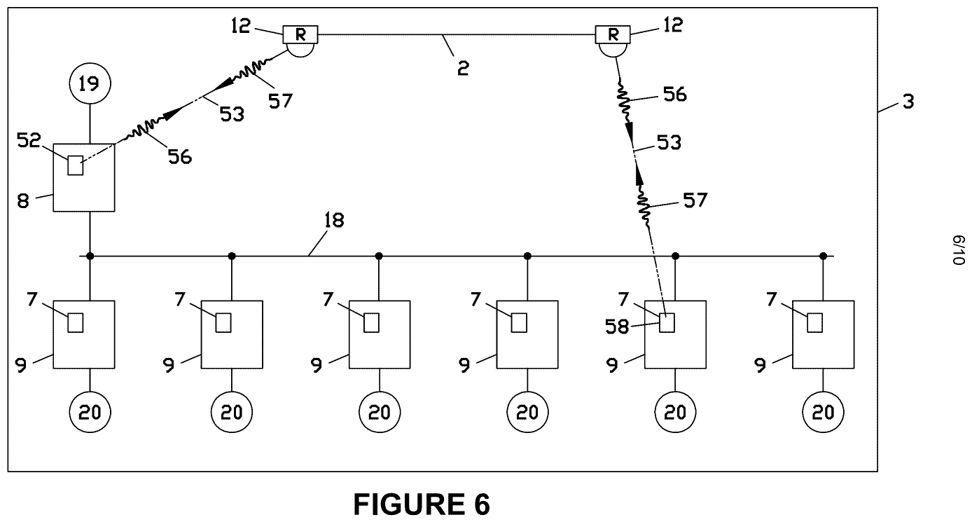

FIG. 6 illustrates the wireless switchgear communication system wherein the duties of the computer controller previously described, are assumed by a circuit breaker relay 52 designated as the communication master which could be the main circuit breaker 8 relay, as an example. The communication master relay 52 controls the communication system and also provides the system-based electrical protection for the switchgear. In this communication system, the roles of the duplex OWC access points are assumed by a single or multiple duplex OWC relays 12. The communication path, as illustrated in FIG. 6, between the communication master relay 52 and a specific target relay 58 is via an optical path 53 to the first OWC relay, a digital electronic path 2 from the first OWC relay to the second OWC relay and then an optical path 53 from the second OWC relay to the target relay 58. The OWC relays 12, therefore, act as relay points between the communication master relay 52 and the multiple relays 7 in the switchgear. For example, a message 56 sent by the master relay 52 addressed to a specific relay 58 is received by a first OWC relay 12 and is re-transmitted by a second OWC relay 12 with the address of the recipient relay 58 that was encoded in the message. The reply message 57 from the recipient relay 58 is then re-transmitted by an OWC relays 12 working in cooperation and with the address of the communication master relay 52. The communication master relay 52 may also log data from all or some of the relays 7 in the switchgear and may also send commands to these relays. The optically opaque barrier 3 limits the active communication area.

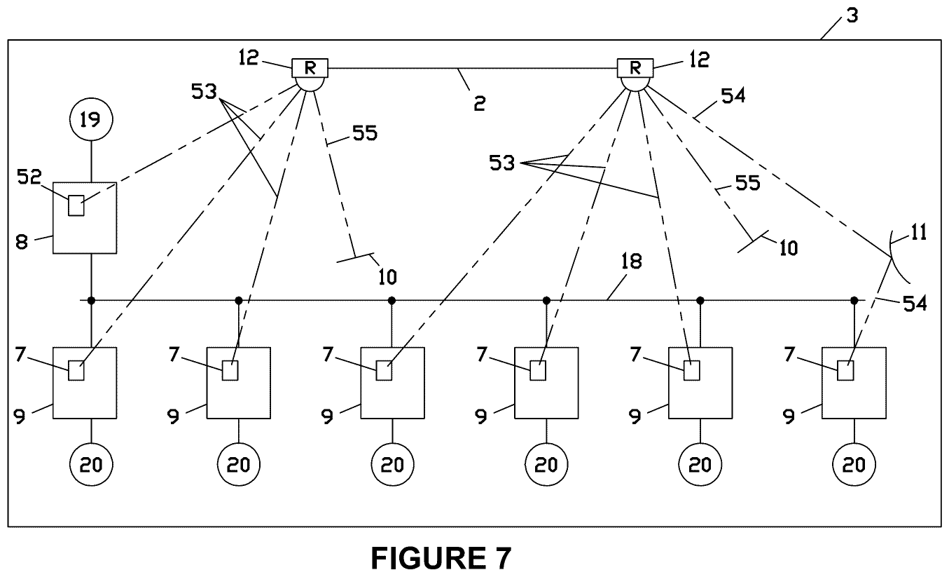

FIG. 7 illustrates the possible optical communication paths between the master communication relay 52 and the multiple relays 7 in the switchgear. As illustrated in FIG. 7, the multiple duplex OWC relays 12 allocate the communication to the multiple relays 7 based on communication parameters, such as the signal strength received from the relays, as an example. If a particular duplex OWC relay 12 loses its communication path 55 to one of its allocated relays due to a blocking object 10, for example, communication to that blocked relay is transferred to a different duplex OWC relay. Additionally, if line-of-sight communication 55 is blocked by an object 10, the communication to that relay may still be possible utilizing a reflected OWC signal 54 from an optical reflector 11. The decision of transferring a communication task to a different duplex OWC relay or relying on a reflected OWC signal is determined based on communication parameters, such as the signal strength received from the blocked relay, as an example.

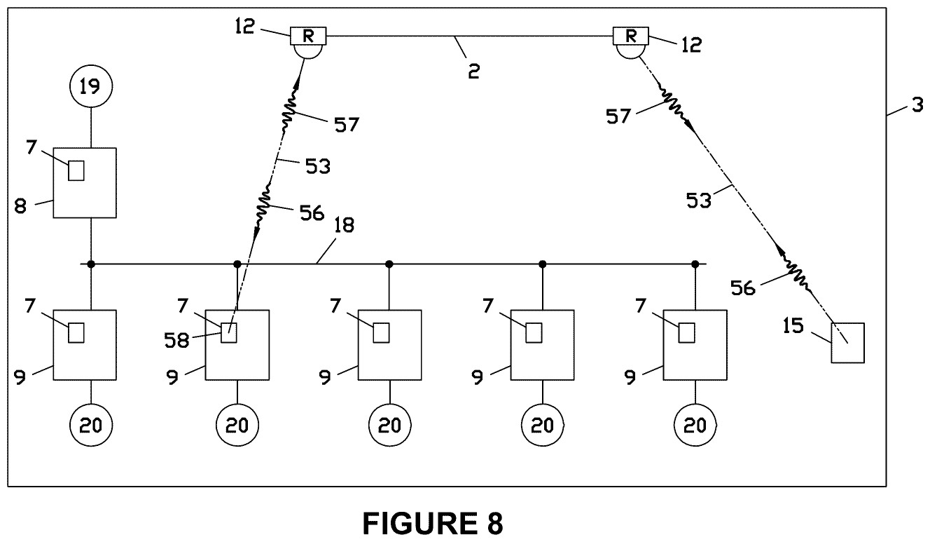

As illustrated in FIG. 8, one or more computer controllers 15 can be added to the wireless switchgear communication system of FIG. 6 and FIG. 7. For simplicity, only one computer controller 15 is shown in FIG. 8. The relay 7 in the main circuit breaker 8 can still be designated the master communication relay and can still control the switchgear communication with the computer controller 15 acting as a slave; however, in the implementation shown in FIG. 8, a computer controller 15 acts as the communication master. Again, the duplex OWC relays 12 work in cooperation and act as relay points between the communication master controller 15 and the multiple relays 7 over the optical links 53. A message 56 sent by the communication master computer controller 15 is received by a first duplex OWC relay 12 and is optically re-transmitted with the address of the recipient relay 58 that was encoded in the message by the second OWC relay 12. The reply message 57 from the recipient relay 58 is then received by the second OWC relay and re-transmitted by the first OWC relay 12 with the address of the communication master computer controller 15. The communication master computer controller 15 may also log data from all or some of the relays 7 in the switchgear and may also send commands to these relays. The optically opaque barrier 3 limits the active communication area.

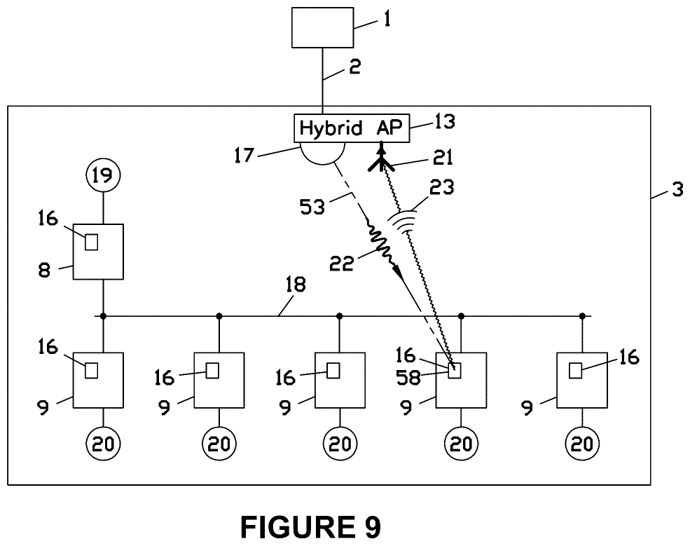

FIG. 9 illustrates a possible implementation of a hybrid OWC system for a single ended switchgear using a hybrid OWC access point 13 with a wired connection 2 to a computer controller 1. The wired connection 2 could be an Ethernet connection, as an example. In this implementation of a hybrid OWC system, the hybrid OWC access point 13 contains an OWC transmitter 17 and an RF receiver antenna 21. The relays 16 in this implementation of a hybrid communication system receive messages via modulated optical light signals 22 from the hybrid OWC access point 13 and transmit reply messages via RF signals 23 to the hybrid OWC access point 13.

In the example of FIG. 9, the computer controller 1 controls the communication system, provides the system-based electrical protection, is the repository of the system data, and initiates circuit breaker commands including racking commands. The computer controller 1 sends messages in Ethernet format, for example, via the wired connection 2 to the hybrid OWC access point 13 which transmits the message to the intended relay 58 via a modulated light signal 22. The RF based reply message 23 from the intended relay 58 is received by the hybrid OWC access point 13 and is converted to an Ethernet format, for example, and forwarded to the computer controller 1.

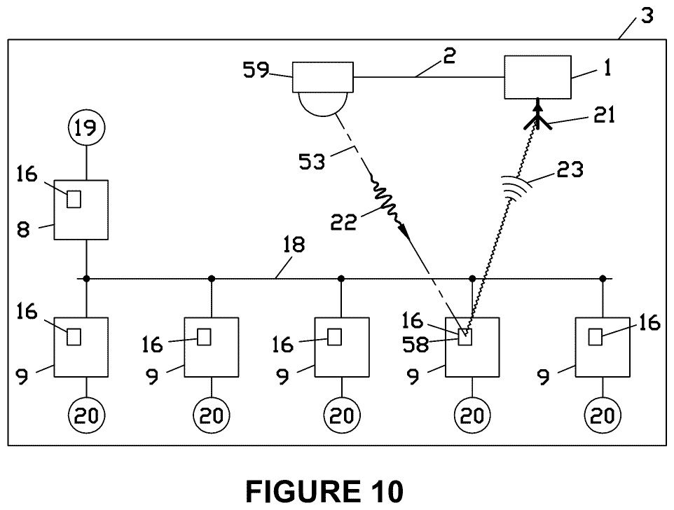

FIG. 10 illustrates a possible implementation of a hybrid OWC system for a single ended switchgear using an OWC transmitter 59 with a wired connection 2 to a computer controller 1 that contains an RF receiver antenna 21. The relays 16 in this implementation of a hybrid communication system receive a message via modulated optical light signals 22 from the OWC transmitter 59 and transmit the reply message via RF signals 23 directly to the computer controller 1. Although shown as a single device in FIG. 10, the OWC transmitter 59 may by a group of OWC transmitters operatively connected by wiring and acting in cooperation.

In the example of FIG. 10, the computer controller 1 controls the communication system, provides the system-based electrical protection, is the repository of the system data, and initiates circuit breaker commands including racking commands. The computer controller 1 sends a message in Ethernet format, for example, via the wired connection 2 to the OWC transmitter 59 which transmits the message to the intended relay 58 via a modulated light signal 22 over optical path 53. The RF based reply message from the intended relay 58 is received directly by the computer controller 1 via the RF signal 23.

The hybrid communication implementations of FIG. 9 and FIG. 10 provide security from outside influences since the communication of information to the relays 16, which may include commands of various types, is made via modulated light signals 22 and the communication limiting boundary 3 blocks modulated light signals originating from outside of the boundary 3.

The wireless communication systems illustrated in FIG. 4 through FIG. 10 can be used to implement system-based electrical protection, as well as data collection and also transference of circuit breaker control commands and circuit breaker racking commands.

### Communication System Condition Diagnostics

The health of the wireless communication system is continuously monitored by the success of the routine communication and periodic special communication intended to detect communication issues and to optimize the communication system performance. Whenever multiple OWC access points or OWC relays are used in the communication system, the relay allocations to a particular OWC access point or relay are periodically verified and the relay is re-allocated as necessary to maintain a robust communication system. Communication system errors are annunciated by the computer controller or the master communication relay.

What is claimed is:

1. An optical wireless communication (“OWC”) system for circuit breaker protection relays wherein the optical wireless communication comprises modulated unguided visible, infrared (“IR”), or ultraviolet (“UV”) light, each configured to carry a signal, the OWC system comprising:
an OWC transceiver operatively coupled to, and associated with, a circuit breaker protection relay;
a single or multiple OWC access points located to allow bidirectional line-of-sight and reflected communication with a single or multiple circuit breaker protection relay OWC transceivers; and
a controller operatively connected to the single or multiple OWC access points.

2. The OWC system of claim 1, wherein the connection between the single or multiple OWC access points and the controller is an Ethernet wired connection.

3. The OWC system of claim 1, wherein the controller comprises multiple operatively interconnected controllers.

4. The OWC system of claim 1, wherein the controller controls the communication between the single or multiple OWC access points and the single or multiple circuit breaker protection relay OWC transceivers using a master and slave protocol.

5. The OWC system of claim 1, wherein the controller is configured to gather data from a single or multiple circuit breaker protection relays via the OWC system, wherein the data includes at least one of phase currents, neutral current, GF current, phase voltages, power data, harmonic data, protection relay settings, alarms, waveforms, serial number, protection relay address, circuit breaker open closed status, circuit breaker springs charged status, date time stamp, or message integrity code verification.

6. The OWC system of claim 5, wherein the data from the single or multiple circuit breaker protection relays is used by the controller to provide system-based electrical protection by analyzing the data and determining if action is required by any of the system-based protection schemes, and if action is required, downloading a trip (open) command to an appropriate protection relay or relays, wherein the system-based electrical protection includes at least one of differential protection, ZSI protection, MTM GF protection, or breaker failure protection.

7. The OWC system of clam 6, wherein the data from the single or multiple circuit breaker protection relays is used for operator information and data logging.

8. The OWC system of claim 6, wherein the controller is configured to transfer data and commands to the single or multiple circuit breaker protection relays, wherein the data and commands include at least one of protection relay setting values, breaker open or close commands, breaker racking settings, breaker racking commands, or time synchronizing data.

9. A combination optical wireless communication (“OWC”) and radio frequency (“RF”) wireless communication (“hybrid OWC”) system for circuit breaker protection relays, wherein the optical wireless communication portion comprises modulated unguided visible, infrared (“IR”), or ultraviolet (“UV”) light, each configured to carry a signal in one direction and an RF communication portion configured to carry a signal in the other direction, the hybrid OWC system comprising:
an OWC receiver and an RF transmitter operatively coupled to, and associated with, a circuit breaker protection relay;
a single or multiple combination optical and RF hybrid OWC access points arranged to allow optical communication in one direction and RF communication in the other direction with a single or multiple circuit breaker protection relays; and
a controller operatively connected to the single or multiple combination optical and RF hybrid OWC access points.

10. The hybrid OWC system of claim 9, wherein the connection between the single or multiple combination optical and RF hybrid OWC access points and the controller is an Ethernet wired connection.

11. The hybrid OWC system of claim 9, further comprising multiple combination optical and RF hybrid OWC access points with an Ethernet or wired connection to the controller.

12. The hybrid OWC system of claim 9, wherein the controller comprises multiple operatively interconnected controllers.

13. The hybrid OWC system of claim 9, wherein the controller controls the communication between the single or multiple combination optical and RF hybrid OWC access points and the single or multiple circuit breaker protection relays using a master and slave protocol.

14. The hybrid OWC system of claim 9, wherein the controller is configured to gather data from the single or multiple circuit breaker protection relays, wherein the data includes at least one of phase currents, neutral current, GF current, phase voltages, power data, harmonic data, protection relay settings, alarms, waveforms, serial number, protection relay address, circuit breaker open closed status, circuit breaker springs charged status, date time stamp, or message integrity code verification.

15. The hybrid OWC system of claim 14, wherein the data from the single or multiple circuit breaker protection relays is used by the controller to provide system-based electrical protection by analyzing the data and determining if action is required by the system-based protection schemes, and if action is required, downloading a trip (open) command to the appropriate protection relay or relays, wherein the system-based electrical protection includes at least one of differential protection, ZSI protection, MTM GF protection, or breaker failure protection.

16. The hybrid OWC system of claim 14, wherein the data from the single or multiple circuit breaker protection relays is used for operator information and data logging.

17. The hybrid OWC system of claim 9, wherein the controller is configured to transfer data and commands to the single or multiple circuit breaker protection relays, wherein the data and commands include at least one of protection relay setting values, breaker open or close commands, breaker racking settings, breaker racking commands, or time synchronizing data.

18. An optical wireless communication (“OWC”) system for circuit breaker protection relays, wherein the optical wireless communication comprises modulated unguided visible, infrared (“IR”), or ultraviolet (“UV”) light, each configured to carry a signal, the OWC system comprising:
an OWC transceiver operatively coupled to, and associated with, a circuit breaker protection relay; and
a single or multiple OWC relays arranged to allow bidirectional line-of-sight and reflected communication with a single or multiple circuit breaker protection relay OWC transceivers.

19. The OWC system of claim 18, wherein the single or multiple OWC relays acts as a relay point between multiple circuit breaker protection relays without a wired connection to a controller, wherein a message optically sent by a sender circuit breaker protection relay is received by the single or multiple OWC relays and is optically re-transmitted with an address of a recipient circuit breaker protection relay that was encoded in a message packet, and wherein the single or multiple OWC relays is configured to transfer messages between the circuit breaker protection relays and a controller operatively connected to an OWC transceiver.

20. The OWC system of claim 19, wherein the controller controls communication between the controller and the single or multiple circuit breaker protection relays using a master and slave protocol via the single or multiple OWC relays.

21. The OWC system of claim 19, wherein the controller is configured to gather data from the single or multiple circuit breaker protection relays via the single or multiple OWC relays, wherein the data includes at least one of phase currents, neutral current, GF current, phase voltages, power data, harmonic data, protection relay settings, alarms, waveforms, serial number, protection relay address, circuit breaker open closed status, circuit breaker springs charged status, date time stamp, or message integrity code verification.

22. The OWC system of clam 19, wherein data from the multiple circuit breaker protection relays is used by the controller to provide system-based electrical protection by analyzing the data and determining if action is required by any of the system-based protection schemes, and if required, downloading a trip (open) command to the appropriate circuit breaker protection relay or relays, wherein the system-based electrical protection includes at least one of differential protection, ZSI protection, MTM GF protection, or breaker failure protection.

23. The OWC system of claim 19, wherein data from the single or multiple circuit breaker protection relays is used for operator information and data logging by the controller.

24. The OWC system of claim 19, wherein the controller is configured to transfer data and commands to the single or multiple circuit breaker protection relays, wherein the data and commands include at least one of protection relay setting values, breaker open or close commands, breaker racking settings, breaker racking commands, or time synchronizing data.
